(19) United States
(12) Patent Application Publication
(10) Pub. No.: US 2006/0186788 A1
(43) Pub. Date: Aug. 24, 2006

(54) Image display device

(75) Inventors: Toshio Sasamoto, Hamura (JP); Shigemi Hirasawa, Chiba (JP); Yuuichi Kijima, Chousei (JP); Noriyuki Oroku, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/351,819

(22) Filed: Feb. 9, 2006

(30) Foreign Application Priority Data
Feb. 10, 2005 (JP) 2005-033855

(51) Int. Cl. H01J 63/04; H01J 1/62

(52) U.S. Cl. 313/495; 313/496

(57) ABSTRACT

An image display device according to the present invention includes a front-surface panel SUB2, a rear-surface panel SUB1, and an outer frame FR. Here, the front-surface panel SUB2, the rear-surface panel SUB1, and the outer frame FR are fixed to each other by frit glass FT. Also, an internal hermetically-closed space surrounded by the front-surface panel SUB2, the rear-surface panel SUB1, and the outer frame FR is maintained at a lower pressure than that of the outside. Moreover, the outer frame FR is formed of a sintered body of glass paste.

### INCORPORATION BY REFERENCE

The present application claims priority from Japanese application JP-2005-033855 filed on Feb. 10, 2005, the content of which is hereby incorporated by reference into this application.

### BACKGROUND OF THE INVENTION

1. Field of the Invention

The present invention relates to an image display device. In particular, it relates to a flat-plane panel image display device whose internal hermetically-closed space is hermetically maintained at a lower pressure than that of the outside. In detail, it relates to a sealing structure of the outer frame.

2. Description of the Related Art

From conventionally, as display devices which are superior in high-luminance and high-definition characteristics, color cathode-ray tubes have been in wide use. In recent years, however, there has been an increasing rise in the requests for flat-plate-shaped displays (i.e., panel displays) in accompaniment with high picture-quality implementation of information processing devices and television broadcasts. These flat-plate-shaped displays are displays which exhibit not only the high-luminance and high-definition characteristics, but also light-weight and space-saving characteristics.

As the representative examples, liquid-crystal display devices and plasma display devices have already been commercially available. Also, various types of panel-type display devices are now close to becoming commercially available. Examples of such panel-type display devices are a field emission display (which, hereinafter, will also be referred to as “FED”) that allows the high-luminance implementation in particular, and an organic EL display that is characterized by low power-consumption implementation.

Of the panel-type display devices like this, in an image display device where a hermetically-closed space between two pieces of panels, i.e., front-surface panel and rear-surface panel, is maintained at a lower pressure than that of the outside or is exhausted into vacuum, there exist the following requirements: Namely, the spacing between the two pieces of panels be held at a predetermined value, and also hermeticity be maintained in the hermetically-closed space. The formation of the hermetically-closed space in the opposed spacing between the two pieces of panels requires that a spacing holding member (which will also be referred to as “spacer” or “separation wall”) intervene and be inserted between outer-circumference inner-rim portions of both panels. This spacing holding member can be obtained by coating an adhesive agent (such as frit glass) using such a method as coating with a dispenser or multiple printing. However, if the spacing between the two panels is large, the spacing holding member formed by this kind of coating method finds it difficult to hold the desired spacing. This is because there occurs such a phenomenon as flow or deformation of the adhesive agent. Also, the multiple printing as described above necessitates enormous amounts of time.

For example, in the FED where the spacing between the two panel substrates is large, glass plates are used as the panel material. Also, the spacing of the hermetically-closed space formed between these glass plates (i.e., front-surface panel and rear-surface panel) is equal to more or less about I mm, or about I mm or more. The above-described spacing is formed by fixing with an adhesive agent these front-surface panel and rear-surface panel onto an outer frame formed of a glass material in necessary thickness.

FIG. 9 is a schematic cross-sectional view for explaining a configuration embodiment of the field emission display device (: FED) as an example of this type of panel-type image display devices. In this field emission display device, circumferential-rim inner walls of a rear-surface panel 1 and a front-surface panel 2 are fixed by an outer frame 3. Also, the inside surrounded by this outer frame 3 is implemented into a lower-pressure or vacuum hermetically-closed space. The outer frame 3, which is about 3 to 10 mm thick and about 1 to 5 mm high, is fixed onto the rear-surface panel 1 and the front-surface panel 2 with adhesive agents 4.

Cathode electrodes 5, insulating layers 6, and lattice electrodes 7 are formed on the inner surface of the rear-surface panel 1. Also, anode electrodes 8 and fluorescent substances 9 are formed on the inner surface of the front-surface panel 2. One pair of an anode electrode 8 and a fluorescent substance 9 constitutes one pixel. In the case of color display, one group of different and adjacent three fluorescent substances which emit lights of different colors (in general, red, green, and blue) constitutes one color-pixel. Incidentally, separation walls 10 composed of an insulating material are set up between the respective pixels.

This type of FED allows predetermined colors to be produced as follows: Namely, electron beams emitted from the cathode electrodes 5 are caused to collide with the fluorescent substances 9 multilayered on the anode electrodes 8, thereby producing the predetermined colors. At this time, the electron beams are controlled based on image information applied to the lattice electrodes 7.

FIG. 10A and FIG. 10B are exploded perspective views for schematically explaining a configuration embodiment of the conventional sealing structure including the rear-surface panel, the front-surface panel, and the outer frame illustrated in FIG. 9. As illustrated in FIG. 10A, the outer frame 3 to be formed between the rear-surface panel 1 and the front-surface panel 2 is formed into an integrated-type frame-shaped configuration. First, on respective aperture end surfaces of the outer frame 3 opposed to the inner surfaces of the rear-surface panel 1 and the front-surface panel 2, adhesive agents 3a and 3b such as, e.g., frit glass are caused to intervene by being coated using such a method as printing. Then, after being temporarily bonded, the rear-surface panel, the front-surface panel, and the outer frame are fixed to each other by a firing. Moreover, the internal space constituted by the rear-surface panel 1, the front-surface panel 2, and the outer frame 3 is implemented into a lower-pressure or hermetic space.

Also, as illustrated in FIG. 10B, in another conventional configuration embodiment, first, the outer frame 3 is formed in a manner of being divided into plural types of respective prism-shaped rod members 3a1, 3a2, 3b1, and 3b2. Then, not-illustrated adhesive agent is coated on respective joint surfaces of the respective rod members 3a1, 3a2, 3b1, and 3b2. Next, the respective rod members are combined into a frame configuration, thereby forming the frame body. After that, adhesive agent is caused to intervene by being coated on the respective aperture end surfaces of this frame body by using such a method as printing. Moreover, the panels and the outer frame are fixed to each other by a firing. Furthermore, the internal space is implemented into a lower-pressure or hermetic space.

FIG. 11 is a diagram for explaining outline of a process flow for forming the display-panel outer frame which constitutes the image display device explained in FIG. 9. In FIG. 11, firstly, at first processing steps, a front-surface glass constituting the front-surface panel 2 is prepared (step ST101). Then, black-matrix films are coated on the inner-surface side of this front-surface glass by using the printing method (step ST102). After that, fluorescent substances are coated using the printing method (step ST103).

Next, frame-glass bonding frit glass is coated on the outer-circumference inner-rim portion of the front-surface glass by using the printing method (step ST104). After that, this frit glass is dried, heated and fired, and is melted to disperse the solvent, thereby being temporarily bonded (step ST105). After that, by using a vapor deposition method, metal-back films as the anodes are formed on the fluorescent substances formed on the inner surface of the front-surface glass (step ST106). Next, the frame or rod members illustrated in FIG. 10 is or are assembled on this temporarily-fixed frit glass. After that, by firing the assembled frame or rod members again, this outer frame 3 is temporarily bonded (step ST107).

Meanwhile, at second processing steps, a rear-surface glass constituting the rear-surface panel 1 is prepared (step ST108). Then, the cathode electrodes and the like are formed on the inner-surface side of this rear-surface glass (step ST109). Next, basically the same frame-glass bonding frit glass as the above-described one is coated on the outer-circumference inner-rim portion of this rear-surface glass by using the printing method (step ST110). After that, this frit glass is dried, heated and fired, and is melted to disperse the solvent, thereby being temporarily bonded (step ST111).

Next, the front-surface glass and the rear-surface glass are combined in a manner of being opposed to each other with the frame glass intervening therebetween. Here, the frit glass is temporarily bonded on the outer-circumference inner-rim portion of the front-surface glass at the first processing steps. Also, the frit glass is temporarily bonded on the outer-circumference inner-rim portion of the rear-surface glass at the second processing steps. Then, the front-surface glass and the rear-surface glass are heated and fired while applying a predetermined pressure to the outer surfaces of the front-surface glass and the rear-surface glass. This processing re-melts the frit glasses, thereby pasting together the front-surface glass and the rear-surface glass. As a result, the glasses are bonded and fixed, thus being sealed. Lastly, an internal hermetically-closed space bonded and fixed is exhausted. This allows configuration of a hermetically sealed vacuum container (step ST112).

Namely, the rear-surface panel that the plurality of electron sources are formed on the inner surface of the rear-surface glass, and the front-surface panel that the anode electrodes and the fluorescent substances are formed on the inner surface of the front-surface glass opposed to the electron-sources formed surface of the rear-surface glass are located in the opposed manner with the predetermined spacing placed therebetween. Moreover, the outer-circumference inner-rim portions of the rear-surface panel and the front-surface panel are pasted together with the outer frame intervening therebetween. This has allowed the configuration of the vacuum container. Incidentally, this embodiment has been known in, e.g., JP-A-2000-21335 and JP-A-8-22782.

### SUMMARY OF THE INVENTION

In the image display device configured as described above, the outer frame, which bonds and fixes the two pieces of opposed rear-surface panel and front-surface panel, is configured as follows: Namely, a large-sized plate-glass material is cut off into a large number of rod-shaped glass members which are in size of about 3 to 10 mm. Moreover, after polishing the cut-off planes, the rod-shaped glass members are combined into the frame-shaped configuration, thereby forming the outer frame. This considerably complicated method results in an increase in the number of the machining steps. Accordingly, there existed a problem that it is difficult to form the sealing structure with a high productivity and at a low cost. Namely, it was difficult to accomplish the low-cost implementation.

Also, in the case of small-volume production of the image display devices, the manufacturing cost of the outer frames becomes expensive. Also, in the case of the mass-volume production, the use of glass extraction rods can be considered. There existed a problem, however, that it is difficult to implement availability of the glass extraction rods in compliance with the production scheme, and the like.

Furthermore, in the case where the image display device becomes large-sized, there existed a problem that the rod-shaped glass members becomes likely to be damaged when dealt with. Also, there existed a problem that meaningless wastes occur in taking the raw material thereof, and eventually, the manufacturing cost turns out to become expensive.

Consequently, the present invention has been devised in order to solve the above-described conventional problems. The present invention makes it possible to implement, at a low cost, a sealing structure capable of maintaining hermeticity of the hermetically-closed space. Simultaneously, the present invention makes it possible to provide an image display device whose productivity and reliability are enhanced.

An image display device according to the present invention includes a front-surface panel, a rear-surface panel, and an outer frame. Here, the front-surface panel, the rear-surface panel, and the outer frame are fixed to each other by joint material. Also, an internal hermetically-closed space surrounded by the front-surface panel, the rear-surface panel, and the outer frame is maintained at a lower pressure than that of the outside. Moreover, the outer frame is formed of a sintered body of glass paste. This makes unnecessary the frame glass members which constitute the outer frame.

Also, another image display device according to the present invention is, preferably, as follows: In the above-described configuration, the outer frame is formed on an outer-circumference inner rim of the front-surface panel, and is bonded and fixed to an outer-circumference inner rim of the rear-surface panel via the joint material.

Also, another image display device according to the present invention is, preferably, as follows: In the above-described configuration, the outer frame is formed on an outer-circumference inner rim of the rear-surface panel, and is bonded and fixed to an outer-circumference inner rim of the front-surface panel via the joint material.

Also, another image display device according to the present invention is, preferably, as follows: In the above-described configuration, the outer frame is fixed to an outer-circumference inner rim of the front-surface panel and an outer-circumference inner rim of the rear-surface panel. Also, aperture ends of the outer frame are mutually fixed to each other via the joint material.

Also, another image display device according to the present invention is, preferably, as follows: In the above-described configuration, the outer frame is rectangular in its cross section.

Also, another image display device according to the present invention is, preferably, as follows: In the above-described configuration, the hermetically-closed space is vacuum.

Also, another image display device according to the present invention is, preferably, as follows: In the above-described configuration, the joint material is frit glass.

Also, another image display device according to the present invention is, preferably, as follows: In the above-described configuration, the rear-surface panel includes a field emission element.

Also, another image display device according to the present invention is, preferably, as follows: In the above-described configuration, spacing between the front-surface panel and the rear-surface panel is equal to 1 mm or more.

Also, another image display device according to the present invention is, preferably, as follows: In the above-described configuration, a plurality of spacing holding members are provided between the front-surface panel and the rear-surface panel which are opposed to each other.

Incidentally, the present invention is not limited to the above-described respective configurations and configurations described in embodiments which will be described later. Namely, it is needless to say that various types of modifications are made executable without departing from the technical ideas of the present invention.

According to the present invention, the outer frame is formed of the sintered body of glass paste. This makes it possible to acquire the following exceedingly superior effects: Namely, it becomes possible to manufacture the outer frame more easily and at a less expensive cost in both the machining expense and raw-material expense than the manufacturing of the outer frame from the conventional plate-glass material by using the processings such as cut-off and polishing, and the like.

Also, according to the present invention, the outer frame is formed of the sintered body of glass paste. This easily forms, and simplifies the sealing structure of the sealing frame. This, further, makes it possible to acquire the following exceedingly superior effects: Namely, it becomes possible to significantly reduce the number of the manufacturing steps, to enhance the productivity, to tremendously reduce the manufacturing cost, and to implement the high-productivity image display device, and the like.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for explaining a first embodiment of the image display device according to the present invention, FIG. 1(a) being an essential-portion plan view, and FIG. 1(b) being a cross-sectional view resulting from cutting the essential portion along an A-A′ line in FIG. 1(a);

FIG. 2 is a diagram for explaining a process flow for forming a display panel of the image display device illustrated in FIG. 1;

FIG. 3 is a diagram for explaining a second embodiment of the image display device according to the present invention;

FIG. 4 is a diagram for explaining a process flow for forming a display panel of the image display device illustrated in FIG. 3;

FIG. 5 is a more-detailed schematic plan view of the image display device using an MIM-type thin-film electron source as a representative embodiment of the image display device according to the present invention;

FIG. 6 is a partially-cutaway perspective view for further explaining an embodiment of the entire structure of the image display device according to the present invention illustrated in FIG. 5;

FIG. 7 is a cross-sectional view resulting from cutting the embodiment along an A-A′ line in FIG. 6;

FIG. 8 is an explanatory diagram for explaining an embodiment of an equivalent circuit to the image display device to which the configuration of the present invention is applied;

FIG. 9 is the schematic cross-sectional view for explaining the configuration embodiment of the conventional sealing frame in the image display device;

FIG. 10A and FIG. 10B are the exploded perspective views for schematically explaining the configuration embodiment of the conventional sealing structure including the rear-surface panel, the front-surface panel, and the outer frame in the image display device; and

FIG. 11 is the diagram for explaining the process flow for forming the display panel of the image display device illustrated in FIG. 9.

### DETAILED DESCRIPTION OF THE INVENTION

Hereinafter, referring to the drawings for concrete embodiments, the detailed explanation will be given below concerning the concrete embodiments of the present invention. Incidentally, here, the explanation will be given regarding an appliance which results from applying the present invention to the FED. The present invention, however, is also applicable to basically the same image display devices other than that, or to appliances similar thereto.

### Embodiment 1

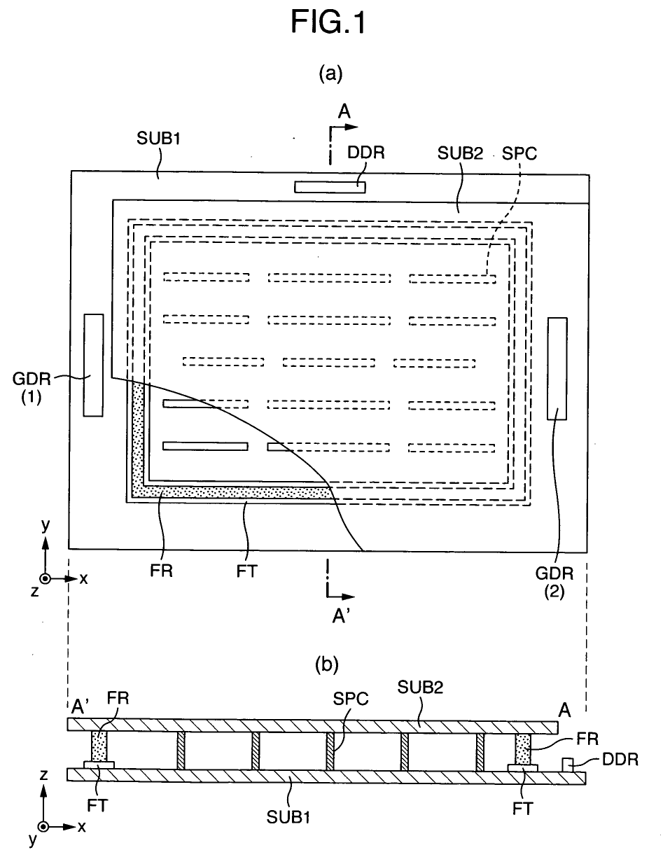

FIG. 1 is a diagram for explaining a first embodiment of the image display device according to the present invention. FIG. 1A and FIG. 1B illustrate a plan view seen from the front-surface substrate side, and a cross-sectional view resulting from cutting the embodiment along an A-A′ line in FIG. 1A, respectively.

In this image display device, a rear-surface panel SUB 1 that a plurality of electron emission sources are formed on the inner-surface side of a substrate composed of plate-glass material, and a front-surface panel SUB 2 that black-matrix films, fluorescent substances, and the like are formed on the inner surface of a light-transparent glass substrate opposed to the electron-emission-sources formed surface (i.e., the inner surface) of this rear-surface panel SUB 1 are located in an opposed manner with a predetermined spacing placed therebetween and with spacing holding members SPC intervening therebetween. Also, frame-glass paste is coated on an outer-circumference inner-rim portion of the front-surface panel SUB 2. Moreover, an outer frame FR, which is composed of a sintered body solidified by being fired, is fixedly attached and located on the outer-circumference inner-rim portion. Incidentally, the rear-surface panel SUB 1 may also be composed of ceramic glass material.

Namely, the outer frame FR is fixedly attached and located on the outer-circumference inner-rim portion of the front-surface panel SUB 2. Also, a rear-surface-panel-side aperture end of the outer frame FR is bonded and fixed on an outer-circumference inner-rim portion of the rear-surface panel SUB 1 by using frit glass FT. This supports the front-surface panel SUB 2 and the rear-surface panel SUB 1 in such a manner that the distance therebetween will be held at the predetermined spacing. As a result, a vacuum container is configured whose internal hermetically-closed space is hermetically sealed. Incidentally, the spacing holding members SPC may also be bonded and fixed at whatever step before and after the step at which the outer frame FR is fixedly attached and located. Additionally, here, illustrations are omitted with respect to respective types of configuration members and exhaustion pipes to be formed on the respective opposed inner surfaces of the rear-surface panel SUB 1 and the front-surface panel SUB 2.

This outer frame FR is configured as follows: First, the outer-frame glass paste whose viscosity is equal to about 100 Pa·s or more is coated on the outer-circumference inner-rim portion of the front-surface panel SUB 2. Here, the outer-frame glass paste is acquired by forming 3-μm to 10-μm average particle-diameter glass powders into paste with a predetermined-viscosity solvent. It is assumed that the black-matrix films, the fluorescent substances, and the like are formed on the inner surface of the front-surface panel SUB 2. A method used for coating the above-described glass paste is, e.g., screen printing method, dispense method, or coater in-batch coating method. After that, the glass paste coated in this way is dried. Furthermore, the glass paste is heated and fired at 500° C. to 580° C., thereby being melted to disperse the solvent. This forms cross section of the outer frame FR into a rectangular configuration which is basically the same as the configuration of the conventional structure.

Incidentally, the above-described glass paste is configured by a composition of at least one kind of metal and the other component such as filer. Here, the above-described one kind of metal is selected from, e.g., ZrO₂, TiO₂, B₂O₃, PbO, SnO₂, ZnO₂, SiO₂, Al₂O₃, and the like.

In this image display device, a large number of data signal wirings are provided side by side in the X direction (i.e., right-to-left direction in FIG. 1(a)) in a manner of extending in the Y direction (i.e., up-and-down direction in FIG. 1(a)). Also, a large number of scanning signal wirings are provided side by side in the Y direction intersecting with the data signal wirings in a manner of extending in the X direction. The first embodiment is based on a scheme that a driving signal to the scanning signal wirings is applied thereto from gate drivers GDR (1) and GDR (2) which are mounted on both sides on right and left in FIG. 1(a). The data signal wirings are driven by a data driver DDR which is mounted on the upper side in FIG. 1(a). (On account of this, from the viewpoint of sealing reliability, it is preferable that a getter room GBX be set up on the lower side in the drawing where there exists no extraction wiring.) Additionally, for simplicity in the explanation, only one gate driver and only one data driver are shown on each side in FIG. 1(a).

The spacing holding members SPC, which are composed of thin plate-glass material or the like, are planted and set up on the scanning signal wirings such that the width direction thereof becomes the Z direction along the longitudinal direction of the scanning signal wirings. This allows the spacing holding members SPC to maintain the spacing between the rear-surface panel SUB 1 and the front-surface panel SUB 2 at the predetermined value. Although, in FIG. 1(a), the four pieces of spacing holding members SPC are set up along the longitudinal direction of each scanning signal wiring, this is merely one example. The location number of the spacing holding members SPC, the spacing therebetween, and the like are determined by such factors as size of the display surface of the image display device, the row material and plate thickness of the rear-surface panel SUB 1 and those of the front-surface panel SUB 2, and the resolutions.

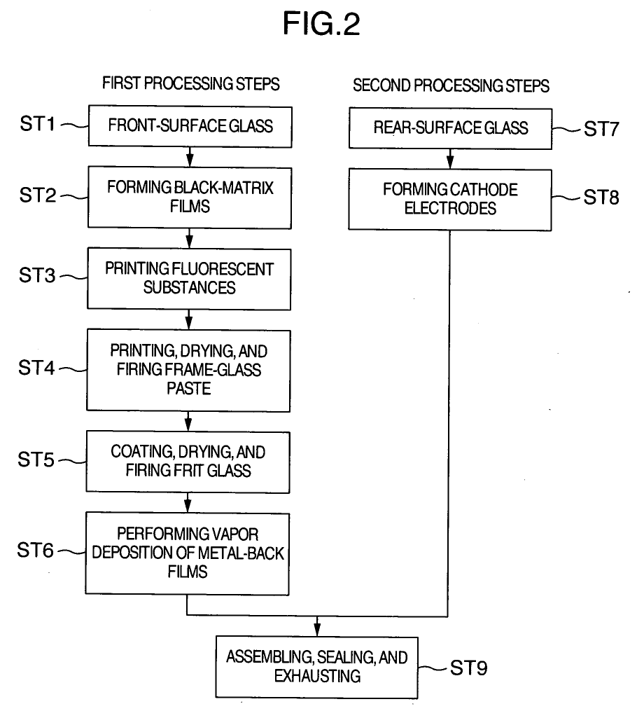

FIG. 2 is a diagram for explaining outline of a process flow for forming the display panel explained in FIG. 1. In FIG. 2, firstly, at first processing steps, a front-surface glass constituting the above-described front-surface panel SUB 2 is prepared (step ST1). Then, the black-matrix films are coated on the inner-surface side of this front-surface glass by using the printing method (step ST2). After that, the fluorescent substances are coated using the printing method (step ST3).

Next, using the screen printing method, dispense method, or coater in-batch coating method, the outer-frame glass paste is coated on the outer-circumference inner-rim portion of the front-surface panel SUB 2 in size of about 6 mm to 8 mm wide and about 2 mm high. Then, after being dried, this glass paste is heated and fired up to about 500° C. to 580° C., thereby being melted to disperse the solvent. This forms an outer frame in the integrated manner. Here, this outer frame is formed, fired and solidified into a rectangular configuration which is basically the same as the configuration of the conventional sealing frame (step ST4).

Still next, using a printing method which is basically the same as the above-described one, frit glass is multilayered and coated on an aperture end of this outer frame. Then, after being dried, this frit glass is heated and fired at a temperature of about 430° C. which is lower than the above-described heating temperature, thereby being temporarily bonded and fixed (step ST5). Lastly, by using a vapor deposition method, metal-back films as the anodes are formed on the fluorescent substances formed on the inner surface of the front-surface glass (step ST6).

Meanwhile, at second processing steps, a rear-surface glass constituting the rear-surface panel SUB 1 is prepared (step ST7). Then, the cathode electrodes as electron sources and the like are formed on the inner-surface side of this rear-surface glass (step ST8). Next, this rear-surface glass is combined with the front-surface glass in a manner of being opposed thereto. Here, the outer frame and the frit glass are temporarily fixed on the outer-circumference inner-rim portion of the front-surface glass at the above-described first processing steps. Then, the glasses combined in this way are re-heated and fired up to a temperature of about 350° C. within, e.g., a nitrogen atmosphere. This processing re-melts the frit glasses, thus bonding and fixing the front-surface glass and the rear-surface glass thereby to seal the glasses. Subsequently, the internal hermetically-closed space bonded and fixed is exhausted. This allows the configuration of the hermetically sealed vacuum container (step ST9). Incidentally, although not illustrated, the bonding and fixing of the spacing holding members is performed at, as an example, a step after the printing, drying, and firing (i.e., the step ST4) of the outer-frame glass paste on the inner surface of the front-surface glass.

The configuration in the first embodiment allows implementation of the in-batch formation of the outer frame FR by performing the processings such as the printing and firing of the glass paste. This makes the frame-glass members unnecessary, and thus makes the machining expense and raw-material expense inexpensive, thereby making it possible to tremendously enhance the productivity. Also, the frame-glass members become unnecessary whose lengths differ on each product-type basis. This makes the machining expense and raw-material expense inexpensive, thereby making it possible to tremendously enhance the productivity.

Also, the configuration in the first embodiment allows implementation of design changes of the outer frame FR, which differ on each product-type basis, only by making changes of the printing mask or coating position changes in the dispenser. This makes it possible to manufacture with a high productivity various types of display panels ranging from the small-sized to the large-sized ones. Also, in the outer frame FR configured in this way, the plate-glass material constituting the panel can be taken in a multi-surface manner from a large-sized plate-glass material. This exceedingly reduces the meaningless wastes in taking the raw material of the plate-glass material, thereby enhancing the yield. This, further, makes it possible to tremendously reduce the cost of the display panel.

### Embodiment 2

Incidentally, in the above-described first embodiment, the explanation has been given concerning the following case: Namely, the outer frame FR is fixedly attached and located on the outer-circumference inner-rim portion of the front-surface panel SUB 2. Moreover, the aperture end of this outer frame FR is bonded and fixed on the outer-circumference inner-rim portion of the rear-surface panel SUB 1 by using the frit glass FT. The present invention, however, is not limited to this case. Utterly the same functions and effects can also be acquired in the following case, for example: Namely, the outer frame FR is fixedly attached and located on the outer-circumference inner-rim portion of the rear-surface panel SUB 1. Moreover, the aperture end of this outer frame FR is bonded and fixed on the outer-circumference inner-rim portion of the front-surface panel SUB 2 by using the frit glass FT.

Incidentally, in this case, after having dried the outer-frame glass paste coated on the outer-circumference inner-rim portion of the rear-surface panel SUB 1, this glass paste is heated and fired in a temperature range of about 500° C. to 580° C. If this firing temperature has exceeded about 600° C., the cathode electrodes formed on the inner-surface side of the rear-surface panel SUB 1 are subjected to thermal damage. This results in a danger of lowering electron emission characteristics of the electron sources constituting the cathode electrodes. In the present embodiment, occurrence of such a malfunction is reduced, since the firing temperature is set at about 580° C. or less.

### Embodiment 3

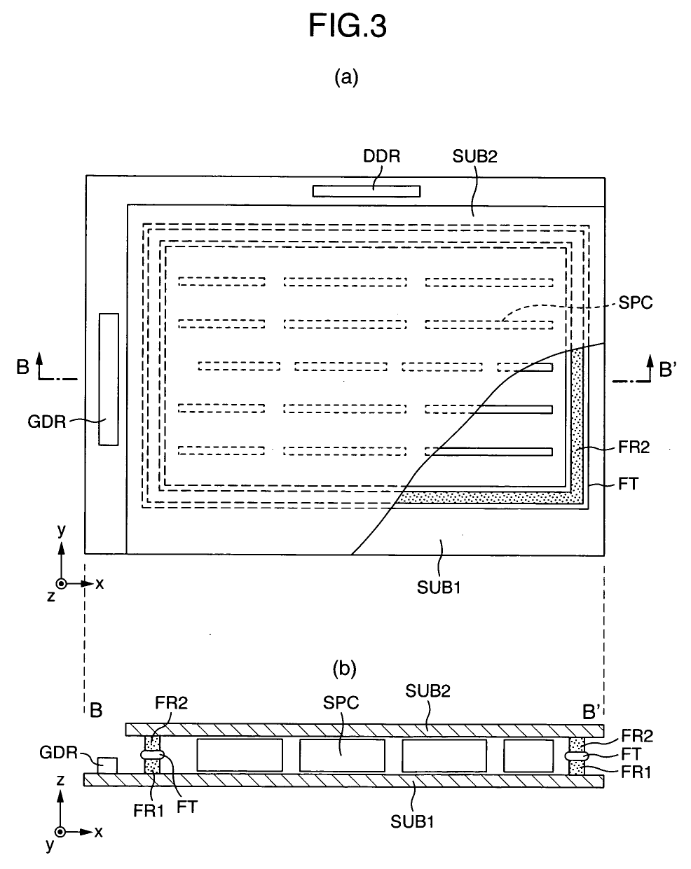

FIG. 3 is a diagram for explaining a third embodiment of the image display device according to the present invention. FIG. 3A and FIG. 3B illustrate a plan view seen from the front-surface substrate side, and a cross-sectional view resulting from cutting the embodiment along an A-A′ line in FIG. 3A, respectively. The same reference numerals are allocated to the same configuration components as those in FIG. 1. In FIG. 3, the point which differs from the configuration in FIG. 1 is as follows: Namely, a first outer frame FR1 composed of a sintered body of the glass paste is fixedly attached and located on the outer-circumference inner-rim portion of the rear-surface panel SUB 1 in an integrated manner. Similarly, a second outer frame FR2 composed of the same sintered body of the glass paste is fixedly attached and located on the outer-circumference inner-rim portion of the front-surface panel SUB 2 as well in an integrated manner. Moreover, the rear-surface panel SUB 1 and the front-surface panel SUB 2 are located in a manner of being opposed to each other. Furthermore, an aperture end of the first outer frame FR1 and an aperture end of the second outer frame FR2 are bonded and fixed by using the frit glass FT. This configures a vacuum container whose internal hermetically-closed space is hermetically sealed.

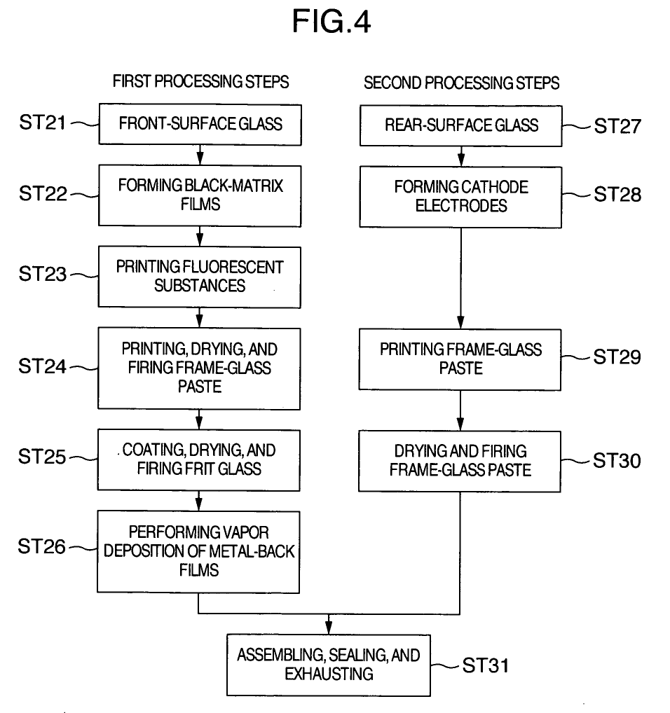

FIG. 4 is a diagram for explaining outline of a process-flow for forming the display panel explained in FIG. 3. In FIG. 4, steps ST21 to ST28 are the same as the steps in FIG. 2. The point which differs from the process flow explained in FIG. 2 lies in the second processing steps. Namely, the second processing steps according to the present embodiment are as follows: At the step ST28, the cathode electrodes are formed on the rear-surface glass. After that, the glass paste is coated on the outer-circumference inner-rim portion of the rear-surface glass (step ST29). Next, this glass paste is dried. After that, the glass paste is heated and fired at about 500° C. to 580° C., thereby being melted to disperse the solvent. This forms the fired and solidified outer frame FR1 in the integrated manner (step ST30).

Incidentally, in-this process, coating widths (height-direction dimension) of the glass pastes, which are coated on the outer-circumference inner-rim portions of the front-surface glass and the rear-surface glass respectively, are required to be made equal to about the one-half the coating width of the glass paste explained in FIG. 2.

Next, the rear-surface glass on which the outer frame FR1 is formed is combined with the front-surface glass in a manner of being opposed thereto. Here, the outer frame FR2 and the frit glass are temporarily fixed on the outer-circumference inner-rim portion of the front-surface glass by being fired at the above-described first processing steps. Then, the glasses combined in this way are re-heated and fired up to a temperature of about 350° C. within, e.g., a nitrogen atmosphere. This processing re-melts the frit glasses, thus bonding and fixing the front-surface glass and the rear-surface glass thereby to seal the glasses.

Subsequently, the internal hermetically-closed space bonded and fixed is exhausted. This allows the configuration of the hermetically sealed vacuum container (step ST31). Incidentally, although not illustrated, as an example, the bonding and fixing of the spacing holding members SPC is performed at a step after the printing, drying, and firing (i.e., the step ST4) of the outer-frame glass paste on the inner surface of the front-surface glass, or at a step after the printing of the glass paste on the outer-circumference inner-rim portion of the rear-surface glass (i.e., the step ST29).

In the configuration in the third embodiment as well, the functions and effects which are basically the same as those in the above-described first embodiment can also be acquired.

Incidentally, in the above-described process flow, the explanation has been given concerning the following case: Namely, on the outer frame formed on the outer-circumference inner-rim portion of the front-surface glass by being fired and solidified, the frit glass is temporarily fixed by being coated, dried, and fired. In substitution for this processing step, however, the following case is also allowable: Namely, on the outer frame formed on the outer-circumference inner-rim portion of the rear-surface glass by being fired and solidified, the frit glass is temporarily fixed by being coated, dried, and fired.

Also, in the above-described respective embodiments, the explanation has been given concerning the case where the cross section of the outer frame FR is formed into the substantially rectangular configuration. The present invention, however, is not limited to this configuration. It is needless to say that the functions and effects which are basically the same as the above-described ones can also be acquired even if the cross section is formed into whatever configuration, e.g., circular configuration, elliptic configuration, or egg-shaped configuration.

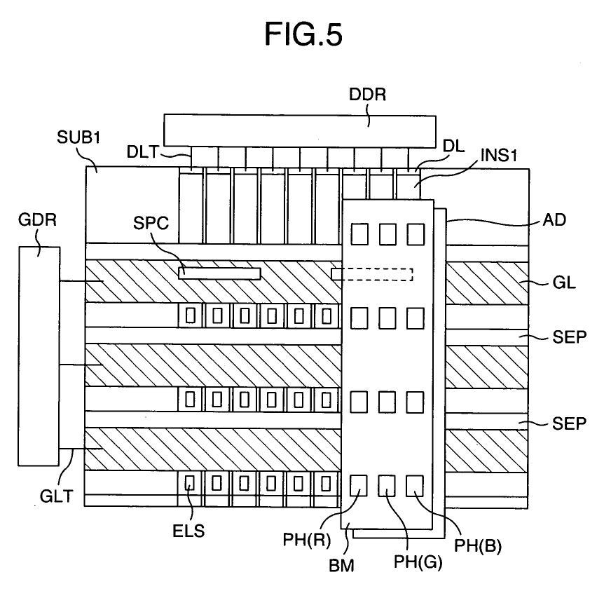

FIG. 5 is a more-detailed schematic plan view of the image display device using an MIM-type thin-film electron source as a representative embodiment of the image display device according to the present invention. Incidentally, FIG. 5 mainly illustrates one glass substrate (i.e., cathode substrate) including the electron emission sources, i.e., the plane of the rear-surface panel SUB 1. Regarding the front-surface panel SUB 2, i.e., the other glass substrate (also referred to as “fluorescent-substance substrate”, “display-side substrate”, or “color filter substrate”), FIG. 5 partially illustrates the black matrix BM, the fluorescent substances PH (R), PH (G), and PH (B), and the anode AD, but does not illustrate the front-surface panel SUB 2 itself.

Signal lines formed on the rear-surface panel SUB 1 are ones such as data signal lines DL and scanning signal lines GL. The data signal lines DL are connected to a data-signal-line driving circuit DDR. The scanning signal lines GL are insulated from the data signal lines DL by insulating layers INS1, located in a manner of intersecting with the data signal lines DL, and connected to a scanning-signal-line driving circuit GDR. A plurality of electron sources ELS are located as an electron-source array. In the electron sources ELS, the data signal lines DL are used as first electrodes, and thin-film electrodes of the scanning signal lines GL multilayered via the tunnel insulating layers are used as second electrodes. Incidentally, reference notations DLT and GLT denote extraction terminals of the data signal lines DL and extraction terminals of the scanning signal lines GL, respectively.

The fluorescent substances PH (R), PH (G), and PH (B) provided on the front-surface panel SUB 2 are opposed to the respective electron sources ELS provided on the rear-surface panel SUB 1. The spacing holding members SPC regulates the distance between the front-surface panel SUB 2 and the rear-surface panel SUB 1 at a predetermined spacing. The thin-film electrodes (i.e., the upper electrodes of the electron sources ELS) are electrically isolated from the adjacent scanning signal lines of the electron-source array by separation portions SEP.

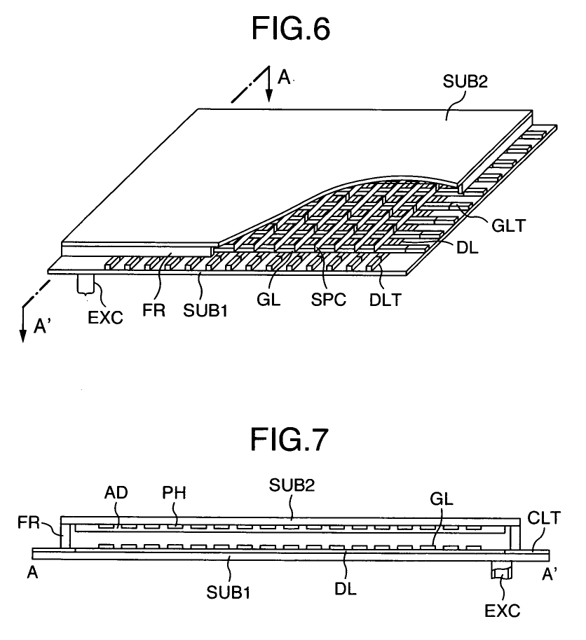

FIG. 6 is a partially-cutaway perspective view for further explaining an embodiment of the entire structure of the image display device according to the present invention illustrated in FIG. 5. Also, FIG. 7 is a cross-sectional view resulting from cutting the embodiment along an A-A′ line in FIG. 6. The data signal lines DL and the scanning signal lines GL are provided on the inner side of the rear-surface panel SUB 1. The electron sources are formed at the intersection points of the data signal lines DL and the scanning signal lines GL. The data-signal-line extraction terminals DLT are formed at the end portions of the data signal lines DL, and the scanning-signal-line extraction terminals GLT are formed at the end portions of the scanning signal lines GL.

The anode AD and the fluorescent substances PH are formed on the inner side of the front-surface panel SUB 2. The rear-surface panel SUB 1 and the front-surface panel SUB 2 are pasted with each other such that the outer frame FR, to which the configuration of the present invention is applied, is caused to intervene therebetween on the outer-circumference inner-rim portions thereof. As exactly described earlier, in order to maintain the pasted spacing at the predetermined value, the spacing holding members SPC preferably composed of glass material are planted and set up between the rear-surface panel SUB 1 and the front-surface panel SUB 2. FIG. 7 illustrates the cross section along these spacing holding members SPC, and accordingly illustration of these spacing holding members SPC is omitted.

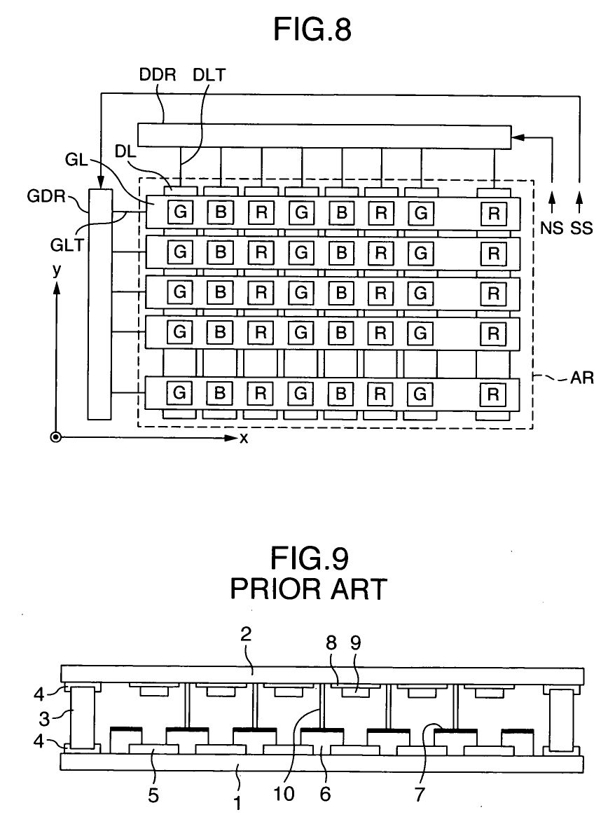

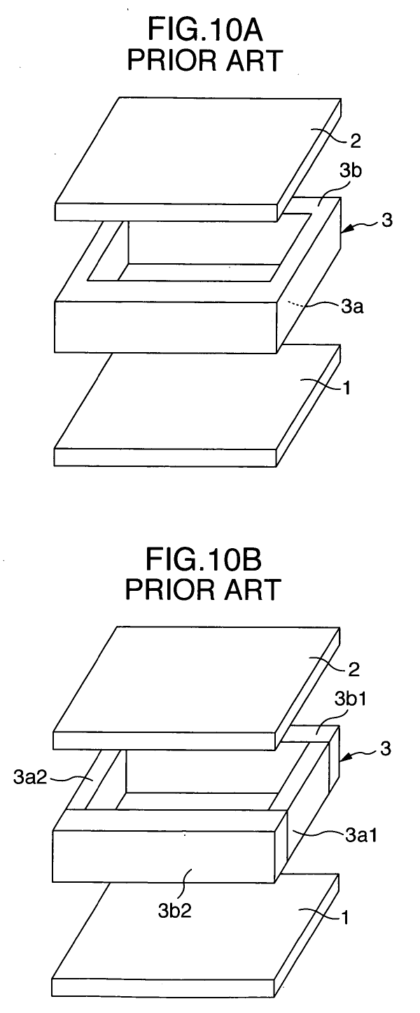

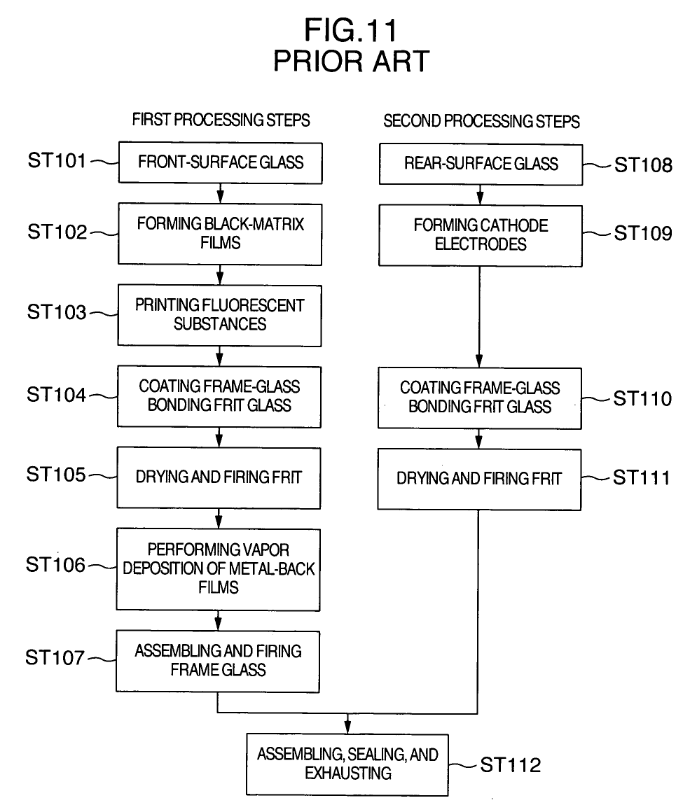

FIG. 8 is an explanatory diagram for explaining an embodiment of an equivalent circuit to the image display device to which the configuration of the present invention is applied. The area indicated by the broken line in FIG. 8 is a display area AR. In this display area AR, n units of data signal lines DL and m units of scanning signal lines GL are located in a manner of intersecting with each other, thereby forming an n-row×m-column matrix. The respective intersection portions of this matrix constitute color sub-pixels. One group of three unit-pixels (or sub-pixels) “R”, “G”, and “B” in the drawing constitutes one color pixel. Incidentally, illustration of configuration of the electron sources is omitted.

The data signal lines DL are connected to the data-signal-line driving circuit DDR via the data-signal-line extraction terminals DLT. The scanning signal lines GL are connected to the scanning-signal-line driving circuit GDR via the scanning-signal-line extraction terminals GLT. An image data signal NS is inputted into the data-signal-line driving circuit DDR from an external signal source. Similarly, a scanning signal SS is inputted into the scanning-signal-line driving circuit GDR therefrom.

This configuration allows display data (i.e., the image signal) to be supplied to the data signal lines DL that intersect with the scanning signal lines GL which are to be sequentially selected. This makes it possible to display a two-dimensional full-color image. The use of the present configuration embodiment allows a high-efficiency spontaneous-light plane display device to be implemented at a comparatively low voltage.

It should be further understood by those skilled in the art that although the foregoing description has been made on embodiments of the invention, the invention is not limited thereto and various changes and modifications may be made without departing from the spirit of the invention and the scope of the appended claims.

1. An image display device, comprising:
a front-surface panel,
a rear-surface panel, and
an outer frame, wherein
said front-surface panel, said rear-surface panel, and said outer frame are fixed to each other by joint material,
an internal hermetically-closed space surrounded by said front-surface panel, said rear-surface panel, and said outer frame being maintained at a lower pressure than that of the outside,
said outer frame being formed of a sintered body of glass paste.

2. The image display device according to claim 1, wherein said outer frame is fixed to an outer-circumference inner rim of said front-surface panel, said outer frame being fixed to an outer-circumference inner rim of said rear-surface panel via said joint material.

3. The image display device according to claim 1, wherein said outer frame is fixed to an outer-circumference inner rim of said rear-surface panel, said outer frame being fixed to an outer-circumference inner rim of said front-surface panel via said joint material.

4. The image display device according to claim 1, wherein said outer frame is fixed to an outer-circumference inner rim of said front-surface panel and an outer-circumference inner rim of said rear-surface panel, aperture ends of said outer frame being mutually fixed to each other via said joint material.

5. The image display device according to claim 1, wherein said hermetically-closed space is vacuum.

6. The image display device according to claim 1, wherein said joint material is frit glass.

7. The image display device according to claim 1, wherein said outer frame is rectangular in its cross section.

8. The image display device according to claim 1, wherein said rear-surface panel includes a field emission element.

9. The image display device according to claim 1, wherein spacing between said front-surface panel and said rear-surface panel is equal to 1 mm or more.

10. The image display device according to claim 1, wherein a plurality of spacing holding members are provided between said front-surface panel and said rear-surface panel which are opposed to each other.
